(19) United States
(12) Patent Application Publication
(10) Pub. No.: US 2020/0347161 A1
(43) Pub. Date: Nov. 5, 2020

(54) PHOSPHORUS-CONTAINING THERMOPLASTIC POLYMERS

(71) Applicant: Chemische Fabrik Budenheim KG, Budenheim (DE)

(72) Inventors: Michael CIESIELSKI, Merseburg (DE); Manfred DÖRING, Wörth am Rhein (DE); Birgit FAßBENDER, Mainz (DE); Thomas FUTTERER, Ingelheim (DE); Hendrik WERMTER, Eltville (DE)

(73) Assignee: Chemische Fabrik Budenheim KG, Budenheim (DE)

(21) Appl. No.: 16/962,649

(22) PCT Filed: Jan. 10, 2019
(86) PCT No.: PCT/EP2019/050482

§ 371 Date: Jul. 16, 2020

(30) Foreign Application Priority Data
Jan. 17, 2018 (DE) 10 2018 100 984.4

(51) Int. Cl. C08F 30/02; C08L 77/06; C08L 69/00; C08L 67/02; C09K 21/14; C08K 5/3492; C08K 3/08; C08K 3/32; C08K 5/5313

(52) U.S. Cl. CPC C08F 30/02; C08L 77/06; C08L 69/00; C08L 67/02; C09K 21/14; C08K 5/34922; C08K 2003/328; C08K 3/08; C08K 3/32; C08K 5/5313; C08L 2201/02; C08K 2003/0893; C08K 5/34924

(57) ABSTRACT

A phosphorous-containing polymer based on an acrylate is described which is not cross-linked or is only slightly cross-linked and forms a polymer. The polymer is suitable as a flame retardant and for use in a flame retardant for plastics.

### SUBJECT MATTER OF THE INVENTION

The invention relates to a phosphorous-containing polymer based on an acrylate, a method for producing the polymer, the use of the polymer and the polymer-containing flame retardant and plastic compositions. The polymer according to the invention is not cross-linked or only slightly cross-linked. The polymer is suitable as a flame retardant and for use in a flame retardant for plastics.

### BACKGROUND OF THE INVENTION

Numerous substances are known for providing fire retardant properties to plastics which can be used alone or in combination with other substances which provide similar or supplementary fire retardant properties. Preferably, halogen-free substances are thus used to avoid the development and release of HX gases and other toxic compounds. Known halogen-free flame retardants include those which are based on metal hydroxides, organic or inorganic phosphates, phosphonates or phosphinates as well as derivatives of 1,3,5-triazine compounds and mixtures thereof.

However, among others, certain monomeric, low-molecular flame retardant additives are known which due to their strong plasticiser effect lead to significant deteriorations of the material properties of the plastic matrix to be protected during processing and also during use. In addition, due to their tendency to migrate in plastics which can lead to aggregation (poorer distribution of flame retardant additive) or leaching (migration to the surface and possible escape from the plastic), with such low-molecular flame retardant additives their flame retardant effect decreases after a certain period of time. Furthermore, leaching can lead to contact between the flame retardant additive that has escaped from the plastic and the environment.

On the other hand, polymeric, high-molecular flame retardant additives generally only have minor plasticiser effects and a low migration capacity. However, in contrast to low-molecular flame retardant additives, in technical processing they are often less miscible with the plastic to be protected, in particular with low melting ability.

From WO 2009/109347 A1 for example a polyester is known which is obtained through the Michael addition of 6H-dibenzo[c,e][1,2]-oxaphosphorine-6-oxide (DOPO) to an itaconic acid and subsequent polycondensation with ethylene glycol. When using this polymer in a plastic matrix, such as a polyester or a polyamide, under usual extrusion conditions (250 to 270° C.) this has a sticky and highly adhesive consistency, whereby in particular in the dosage area blocking and sticking (clogging) of parts of the extrusion apparatus is increasingly observed. In addition, this polymer first starts to degrade from temperatures of approximately 300° C. so that the use in plastic matrices which are processed at very high temperatures, such as polyamide 6.6 (PA 6.6) and most particularly high-temperature polyamides such as polyamide 4.6, is not possible. Furthermore, the polymer only includes one phosphorous-containing group per recurring unit. The maximum phosphorus content is 8.5% by weight.

WO 2014/124933 A2 relates to a duromer phosphorous-containing flame retardant which is obtained by free-radical polymerisation of polyfunctional acrylates. The synthesis of this flame retardant comprises a two-stage process which includes the addition of an organophosphorous compound to a portion of the acrylate groups and the subsequent free-radical polymerisation of the remaining acrylate groups. Although these duromer phosphorous-containing flame retardants have a high degradation temperature of at least 300° C., due to their duromeric structure they are however not meltable and therefore cannot be mixed with the plastic matrix, which is intended to be flame retardant, as a melt. Therefore, they can only be incorporated as solid particles in the plastic matrix. A sufficiently good distribution of this flame retardant can be ensured only to a limited degree even with small grain size and good mixing, and is further impeded by agglomeration of the particles. The uneven distribution of particles leads to a reduction in frame retardant effect, in particular in materials with small diameters. The use is therefore limited to compact plastic moulded bodies. Fibres, films, foams and other materials with small diameters or layer thickness cannot be provided with satisfactory flame retardant effect by means of the corresponding duromers. Furthermore, when using a melt filter in plastics processing machines, this can be blocked by the solid particles in the plastic matrix.

### Object

The object of the present invention is thus to provide a phosphorous-containing polymer which is improved in relation to the prior art and which has similar or even better flame retardant properties than the compounds from the prior art and a very good miscibility with the plastic to be protected in order to overcome the above-mentioned issues.

### DESCRIPTION OF THE INVENTION

This object is achieved according to the invention by a polymer which can be obtained by a method in which in a first step a compound or a mixture of compounds with the general formula I

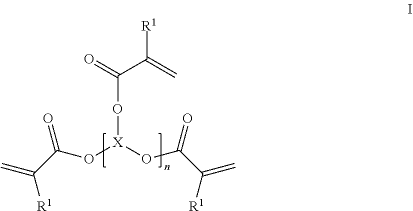

is reacted with a compound with the general formula II or a mixture of compounds with the general formula II

R²—H II

to obtain a compound with the general formula III or a mixture of compounds with the general formula III

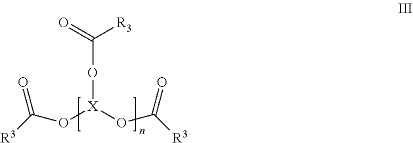

wherein the compound with the general formula III or the mixture of compounds with the general formula III in a second step with the optional addition of one or a plurality of methacrylates and/or acrylates with the general structure IV

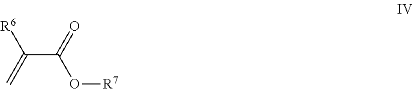

is reacted into a polymer, where

R¹ is hydrogen, a C₁-C₆ alkyl, a C₆-C₁₂ aryl or a C₆-C₁₂ alkylaryl,

R² is

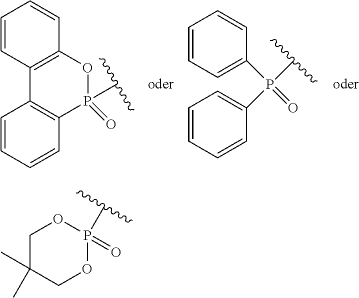

R³ is

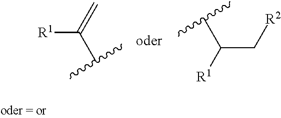

and where X is

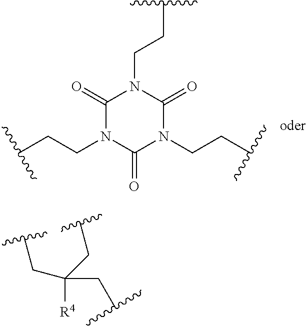

where R⁴ is hydrogen, —CH₂OH, —OH, a C₁-C₆-alkyl, a C₆-C₁₂-aryl, a C₆-C₁₂-alkylaryl or

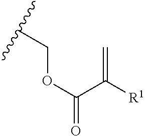

R⁶ and R⁷ independently of one another are hydrogen, C₁-C₆-alkyl, C₆-C₁₂-aryl or C₆-C₁₂-alkylaryl and

in the compounds according to formulae I and III or the mixtures of compounds according to formulae I and III n represents an average chain length in the range of 1 to 100, preferably 1 to 10, particularly preferably 1 to 3,

characterised in that the average number of R³ residue of the formula

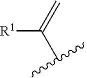

in the compound of formula III or in the mixture of the compound of formula III is 0.8 to 1.3 and the polymer is a thermoplastic.

The polymers according to the invention are linear or branched thermoplastics with a low degree of cross-linking which in the case of amorphous thermoplastics in a temperature range above the glass transition temperature (T_{g}), in the case of crystalline or partially crystalline thermoplastics above the melting temperature (Tₘ) are in principle viscously flowable and can be deformed. This deformation process is reversible which means that is can be repeated many times as required by cooling and reheating in the molten state as long as thermal degradation of the material does not occur by overheating. In the molten state thermoplastics can be easily incorporated for example by means of pressing, extrusion, injection moulding or other moulding processes.

Due to their meltability and flowability, the polymers according to the invention can very easily be evenly mixed and incorporated with meltable plastic matrices under suitable conditions in the molten, flowable state. Thus, a uniform flame retardant effect can be achieved even in plastic matrices with very thin dimensions and the above-mentioned problems in the processing of plastic matrices can be avoided.

In the sense of this invention, the term “plastic matrix” includes any plastic or any mixture of plastics in which the polymer according to the invention can be incorporated.

Surprisingly, the polymers according to the invention have both a high thermostability and a very good flame retardant effect despite the low degree of cross-linking and good meltability and flowability. It would have been expected that a polymer according to the invention would degrade in comparison to the duromers from the prior art, even at significantly lower temperatures and thus in the range of the processing temperatures of common plastic matrices. The flame retardant effect would thus have been significantly reduced or would even have been completely missing.

The thermoplastic according to the invention can be achieved by means of the above-described sequence of reaction steps in which in the first step an organophosphorous compound according to formula II is added to a multifunctional acrylate compound of formula I in a phospha-Michael addition. Thus, the organophosphorous compound according to formula II is used in molar ratio to the compound of Formula I, which results from the following equation:

y(compound of formula I)*W−z(compound of formula II)=0.8−1.3

where y=substance of the compound of formula I, z=substance of the compound of formula II and w=valency=amount of

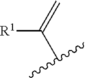

in compounds of formula I.

For example, according to the invention the reaction of a compound of formula I which comprises 4 C—C-double bonds in structural elements of the form

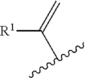

with three equivalents of a compound of formula II leads to a compound of formula III with an average number of C—C-double bonds in structural elements of the form

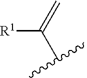

of one.

The substances suitable as a compound of formula II according to the invention are 6H-dibenzo[c,e][1,2]-oxaphosphorine-6-oxide (DOPO, CAS No. 35948-25-5), diphenylphosphine oxide (DPhPO, CAS No. 4559-70-0), 5,5-dimethyl-1,2,3-dioxophosphorinan-2-oxide (DDPO, CAS No. 4090-60-2), preferably DOPO.

The phospha-Michael addition in the first step and the free-radical polymerisation in the second step take place under reaction conditions which are known by the person skilled in the art for the individual reactions. Preferably, the two steps are carried out in organic solvents, such as toluene.

In the first step, the reaction preferably takes place by adding the compound of formula II to the compound of formula I by stirring. Furthermore, the addition of the compounds of formula II preferably takes place in portions in a plurality of steps, particularly preferably continuously over several minutes, most preferably over several hours. Through one or a combination of these addition conditions, it is ensured that large amounts of unreacted compound of formula II do not accumulate in the reaction mixture so that the individual C—C-double bonds in structural elements in the form

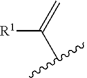

in the compound of formula I gradually react with the compound of formula II, i.e. so that primarily the first C—C-double bond of a structural element in the form of

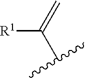

the molecules of the compound of formula I has reacted with the compound of formula II before the second and subsequent C—C-double bonds in structural elements in the form

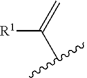

in the compound of formula I react with the compound of formula II. Thus, after the first step, a substantially uniform product of the compound of formula III with a defined quantity of C—C-double bonds in structural elements in the form

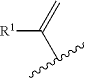

is obtained and not a compound of the formula III with a varied quantity of free C—C-double bonds in structural elements in the form

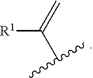

Testing of the completeness of the phospha-Michael addition process and formation of a substantially uniform product is achieved by means of techniques known to those skilled in the art, preferably by NMR spectroscopy, more preferably by ¹H-NMR spectroscopy and/or ³¹P-NMR spectroscopy.

In a preferred embodiment, the polymerisation reaction of the second step is initiated by using free-radical or ionic initiators. Preferably, these are free-radical initiators such as azobis(isobutyronitrile) (AIBN), dibenzoyl peroxide or peroxydisulphate. These provide the advantage that they are very economical and are available in large quantities, and allow a reaction in a plurality of different solvents.

In another embodiment, the polymerisation reaction can be initiated by the influence of radiation, heat and/or a catalyst.

The polymer according to the invention is obtained in pure form after the second reaction step and requires no further purification. Solvents can only be included in particular only by incorporation which can, however, be removed by a subsequent drying step. Such a drying step is preferably carried out at temperatures within the range of approximately 200° C. to 270° C., preferably under vacuum or reduced pressure in the range of approximately 1 mbar to 10 mbar.

Surprisingly, it has been found that the polymer according to the invention has a similar degree, sometimes even a higher degree of thermostability, than the duromers known from the prior art. In addition, the thermoplastic has a higher residual mass after degradation. In the event of a fire, this is advantageous as a lower development of flue gases occurs. The polymer according to the invention preferably has a degradation temperature of at least 320° C. Particularly preferably, the degradation temperature is at least 340° C., most preferably at least 370° C. The polymer is particularly suited for incorporation in a plastic matrix which is to be processed by extrusion as it does not degrade at the usual processing temperatures for the extrusion but only at the higher temperatures occurring during fires and then its flame retardant effect develops.

The degradation temperature of the polymer is determined by means of the thermogravimetric analysis method described in the measurement methods section. The degradation temperature is the temperature at which, at a heating of 10 K/min, a dry sample mass loss of 2% is achieved.

The polymer according to the invention is soluble in a variety of common solvents such as DMSO, DMF, CHCl₃ and THF and can therefore be both processed easily and analysed. For example, chromatographic purification of the obtained polymer can be carried out so that it can be used in applications which require a particularly high degree of purity, such as in medical technology.

Preferably, the degradation temperature of the polymer is higher than the processing temperature of the plastic matrix in the thermal processing method by means of which the polymer is to be incorporated in the plastic matrix. In this way it is ensured that no degradation processes of the polymer take place when the processing temperature of the plastic matrix is reached. Preferably, the degradation temperature of the polymer is more than 10° C. over the processing temperature of the plastic matrix, particularly preferably more than 20° C. over the processing temperature of the plastic matrix, more preferably more than 50° C. over the processing temperature of the plastic matrix.

If the degradation temperature of the polymer is significantly over that of the plastic matrix in which the polymer is incorporated, in the event of a fire the plastic matrix degrades before the polymer can develop a flame retardant effect through its partial degradation. Conversely, i.e. if the degradation temperature of the polymer is significantly below that of the plastic matrix, the degraded polymer can already have undergone subsequent reactions so that its flame retardant effect is substantially reduced. Therefore, preferably, the difference between the degradation temperatures of the polymer and the plastic matrix is less than 100° C., particularly preferably less than 50° C., most preferably less than 20° C.

The meltability and flowability of the polymer according to the invention and the resulting good miscibility with the plastic matrix in which the polymer is incorporated ensure that the melt viscosity of the plastic matrix is barely affected in thermal processing methods so that contrary to the flame retardant of the prior art, no problems are encountered with the thermal processing. For example, when adding the polymer according to the invention, a significant pressure drop on the spinneret during melt spinning, which can lead to capillary breakage of the fibres among other things, is not observed or at least to a lesser extent than with the flame retardants according to the prior art. Sticking and blocking which can lead to pressure fluctuations during thermal processing also do not occur or at least to a lesser extent than with the flame retardants according to the prior art.

A uniform distribution of the flame retardant is achieved by means of the even mixing of the plastic matrix to be provided with the flame retardant with the polymer according to the invention. In this way, it is even possible to effectively protect plastic matrices with thin dimensions such as films, fibres or foams. Furthermore, blocking of the melt filter in plastics processing machines can be avoided by means of even mixing.

By means of the addition of one or a plurality of methacrylates and/or acrylates of the general structure IV before the second step, a copolymer can be obtained and the thermal and mechanical properties such as glass transition point (T_{g}), melting point (Tₘ) or the Young's modulus are thus affected. Furthermore, the compatibility with the plastic matrix can be improved.

In a preferred embodiment, the polydispersity index (PDI) of the polymer is 10 at the most, particularly preferably 5 at the most, most preferably 2.5 at the most. A low PDI enables uniform melting and flow behaviour of the polymer so that it can be better processed.

The PDI can be determined according to common methods known to the person skilled in the art, such as size exclusion chromatography (SEC) in combination with common analysis methods such as light scattering, viscometry, NMR spectroscopy, IR spectroscopy or similar methods.

Due to the structure of the polymer, it can have a plurality phosphorus-containing groups per recurring unit so that a higher phosphorus content is achieved compared to the polymers of the prior art. In this way, a better flame retardant effect is obtained with the same amount of flame retardant. As a result, a flame retardant effect can be achieved with the polymer according to the invention even with very low loads of plastic matrix. The polymer preferably contains two phosphorous-containing groups per recurring unit, more preferably three, particularly preferably four. The phosphorus content of the polymer is preferably at least 8.5% by weight, more preferably at least 8.75% by weight, and most preferably at least 9% by weight in relation to the total weight of the polymer.

In a preferred embodiment, the compound of formula I is selected from among pentaerythritol tetraacrylate (PETA), dipentaerythritol pentaacrylate, dipentaerythritol hexaacrylate, trimethylolpropane triacrylate and tris(2-acryloxyethyl) isocyanurate, pentaerythritol tetraacrylate (PETA, CAS No. 4986-89-4), dipentaerythritol pentaacrylat (DPPA, CAS No, 60506-81-2), dipentaerythritol hexaacrylate (DPEHA, CAS No. 29570-58-9), trimethylolpropane triacrylate (TMPTA, CAS No. 15625-89-5), trimethylolpropane trimethacrylate (TMP-TMA, CAS No. 3290-92-4), tris(2-acryloxyethyl) isocyanurate (THEICTA, CAS No. 40220-08-4).

Particularly preferable are pentaerythritol tetraacrylate (PETA), dipentaerythritol hexaacrylate (DPEHA) and tris(2-acryloxyethyl) isocyanurate (THEICTA).

According to the invention, mixtures of the compounds of formula I can also be used. In order to ensure that in the first step an amount of the compound of formula II is used so that the average quantity of C—C-double bonds in structural elements in the form

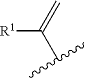

of the compound of formula III is 0.8 to 1.3 after the first step, before the first step the average quantity of C—C-double bonds in structural elements in the form

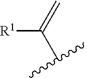

of the compound of formula I is to be determined in such a mixture using methods that are commonly known to the person skilled in the art, such as NMR spectroscopy or titration.

In one embodiment of the invention, the reaction takes places in the first step with a catalyst. A catalyst is a chemical substance, the addition of which makes a specific chemical reaction possible or in the presence of which a reaction proceeds more quickly, as a lower activation energy needs to be used than would be the case in the absence of the catalyst. Preferably, the catalyst is selected from among tertiary amines and tertiary amino bases, particularly preferably this is triethylamine. By adding the catalyst, the reaction in the first step takes place more quickly and at a lower temperature than would be the case without the addition of the catalyst.

In a preferred embodiment, the polymerisation reaction is carried out in an emulsion or suspension, particularly preferably in toluene or xylene. In this case, the thermoplastic soluble in these solvents is in pure form so that only the solvent must be removed and the polymer must be dried.

In a preferred embodiment, the number average of the molar mass of the polymer, M̅ₙ, is at least 5,000 g/mol, particularly preferably at least 10,000 g/mol, particularly preferably at least 20,000 g/mol. By means of a correspondingly high number average molar mass, it is ensured that, due to the high affinity for the plastic and the insolubility in water, only a very low leaching of the polymer from the plastic matrix occurs. Furthermore, by means of a high number average molar mass, the degradation temperature and thus the thermal stability of the polymer is increased. It can then be incorporated in plastic matrices which require particularly high processing temperatures.

The number average of the molar mass of the polymer (M̅ₙ) can be determined using methods that are commonly known to the person skilled in the art. Due to the high degree of accuracy, absolute methods of molar mass determination are particularly suitable for the determination. Examples include membrane osmometry and static light scattering.

The present invention also comprises a method for producing the polymer according to the invention with the method measures represented above.

In a preferred embodiment of the method, the second step is carried out with the addition of one or a plurality of methacrylates and/or acrylates of the general structure IV,

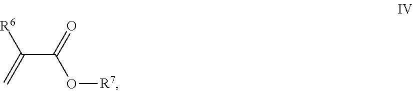

wherein the compounds of formula IV and formula III are incorporated in a molar ratio, in that the obtained polymer contains a weight proportion of 6% by weight phosphorus.

The invention further relates to a flame retardant composition which contains the polymer according to the invention. It has been shown that the polymer can be used advantageously as or in a flame retardant, in particular for flame retardant compositions.

The polymer can be advantageously incorporated in combination with other flame retardants, such as with those which lead to a layer forming on the surface of the plastic matrix provided with the flame retardant due to their degradation at high temperatures. Thus, continued burning of the plastic matrix is prevented if necessary. Moreover, it is also possible to use the polymer with flame retardants which cause flame retardant effect through another mechanism. The interaction of the polymer with other flame retardants can achieve a synergistic effect. Without wishing to be bound by theory, in the event of a fire this seems to cause the degradation temperatures of the polymer and the other flame retardant with which the polymer is combined to be lowered and thus to be closer to the degradation temperature of the polymer matrix. In this way, the flame retardant effect can be increased.

A further advantage of the polymer according to the invention is that it can be incorporated as a replacement for the noxious synergist antimony trioxide (Sb₂O₃). As is shown in the flame retardant examples, the polymer has a synergistic effect in combination with halogenated flame retardants, in particular in combination with bromine-containing flame retardants, such as the brominated polyacrylate FR 1025 from the company ICL, the brominated polystyrene FR-803P from the company ICL or the polymerised bromine-containing epoxy F-2100 from the company Bromine Compounds Ltd. It is also advantageous that in these combinations no additional anti-dripping agent is necessary as the polymer-containing flame retardant composition prevents or reduces dripping itself.

In a preferred embodiment, the flame retardant composition has at least one additional flame retardant component which is preferably selected from among nitrogen bases, melamine derivatives, phosphates, pyrophosphates, polyphosphates, organic and inorganic phosphinates, organic and inorganic phosphonates and derivatives of the aforementioned compounds, preferably selected from among ammonium polyphosphate, with melamine, melamine resin, melamine derivatives, silanes, siloxanes, silicones or polystyrenes coated and/or coated and cross-linked ammonium polyphosphate, as well as 1,3,5-triazine compounds, including melamine, melam, melem, melon, ammeline, ammelide, 2-ureidomelamine, acetoguanamine, benzoguanamine, diaminophenyl triazine, melamine salts and adducts, melamine cyanurate, melamine borate, melamine orthophosphate, melamine pyrophosphate, dimelamine pyrophosphate, aluminium diethylphosphinate, melamine polyphosphate, oligomeric and polymeric 1,3,5-triazine compounds and polyphosphates of 1,3,5-triazine compounds, guanine, piperazine phosphate, piperazine polyphosphate, ethylenediamine phosphate, pentaerythritol, dipentaerythritol, boron phosphate, 1,3,5-trihydroxyethyl isocyanurate, 1,3,5-triglycidyl isocyanurate, triallyl isocyanurate and derivatives of the aforementioned compounds. In a preferred embodiment, the flame retardant composition contains the additional flame retardant components waxes, silicones, siloxanes, fats or mineral oils for better dispersibility.

Preferably, in addition to the polymer according to the invention, the flame retardant composition includes melamine polyphosphate as an additional flame retardant component. Advantageously, this can be used, for example, when applied in a polyamide 6.6-plastic matrix as by combining the flame retardant composition with melamine polyphosphate a synergistic system is created which has a degradation temperature which falls within the degradation temperature range of polyamide 6.6.

In a preferred embodiment, the ratio of the polymer to the at least one additional flame retardant component in the flame retardant composition is 1:18 to 1:4, preferably 1:9 to 1:4 and particularly preferably 1:6 to 1:4. These ratios also apply to the use of melamine polyphosphate as an additional flame retardant component.

The invention further relates to the use of the polymer as a flame retardant or in a flame retardant composition in the production of plastic compositions.

It has been shown that polymers according to the invention have advantageous properties, in particular in the production of plastic compositions by extrusion. Without significantly affecting the processing properties of the different plastic matrices, the polymers can easily be incorporated in these processes. When using the polymers, the thermal and mechanical properties of the plastic matrix after processing are only slightly affected.

Plastic matrices in which the polymer can be used as a flame retardant or in a flame retardant composition are preferably selected from among filled and unfilled vinyl polymers, olefin copolymers, thermoplastic elastomers based on olefins, cross-linked thermoplastic elastomers based on olefins, polyurethanes, filled and unfilled polyesters and copolyesters, styrene block copolymers, filled and unfilled polyamides and copolyamides, polycarbonates and poly(meth)acrylates. Particularly preferred is the use in polymethacrylates and polyacrylates, most preferably in polymethyl methacrylates. In this connection, it is particularly advantageous that the addition of the polymer according to the invention leads to a transparent polymethacrylate or polyacrylate.

However, in principle the polymer and polymer-containing flame retardant compositions are can be used for any plastic matrices. They are suitable as flame retardants for polyamides, polyesters such as polybutylene terephthalate (PBT), polyethylene terephthalate (PET), polyolefins such as polypropylene (PP), polyethylene (PE), polystyrene (PS), styrene block copolymers such as ABS, SBS, SEES, SEPS, SEEPS and MBS, polyurethane (PU), in particular PU rigid and flexible foams, poly(meth)acrylates, polycarbonates, polysulphones, polyether ketone, polyphenylene oxide, polyphenylene sulphide, epoxy resins, polyvinyl butyral (PVB), polyphenylene oxide, polyacetal, polyoxymethylene, polyvinyl acetal, polystyrene, acrylic butadiene styrene (ABS), acrylonitrile styrene acrylate ester (ASA), polycarbonate, polyether sulphone, polysulphonate, polytetrafluoroethylene (PTFE), polyurea, formaldehyde resins, melamine resins, polyether ketone, polyvinyl chloride, polylactide, silicones, polysiloxane, phenolic resins, poly(imide), bismaleimide triazine, thermoplastic elastomers (TPE), thermoplastic elastomers based on urethane (TPU-U), thermoplastic polyurethane, copolymers and/or mixtures of the aforementioned polymers.

Particularly suitable is the use of the polymer according to the invention in plastic matrices which are processed at particularly high temperatures, such as polyamides or polyesters, particularly preferred is the use in PA 6.6 or PA 6 or in high-temperature polyamides, such as polyamide 4.6, partially aromatic polyamides and polyamide 12. Due to the high thermostability of the polymer, this can also be used for such plastics.

In a preferred embodiment, the plastic matrix is selected from among filled or unfilled and/or reinforced polyamides, polyesters, polyolefins and polycarbonates. A filled plastic matrix is understood to mean a plastic matrix which contains one or a plurality of fillers, in particular such which are selected from among the group consisting of metal hydroxides, in particular alkaline earth metal hydroxides, alkali metal hydroxides and aluminium hydroxides, silicates, in particular phyllosilicates and functionalised phyllosilicates such as nanocomposites, bentonite, alkaline earth metal silicates and alkali metal silicates, carbonates, in particular calcium carbonate, as well as talc, clay, mica, silica, calcium sulphate, barium sulphate, aluminium hydroxide, magnesium hydroxide, glass fibres, glass particles and glass beads, wood flour, cellulose powder, carbon black, graphite, boehmite and dyes.

All of the listed fillers can be used both in the usual form and size for fillers which are known to the person skilled in the art, as well as in nanoscale form, i.e. as particles having an average diameter in the range of approximately 1 to approximately 200 nm, and can be used in the plastic compositions.

To reinforce the plastic composition and to increase its mechanical stability, glass fibres are preferably added as a filler.

In a preferred embodiment, the polymer is introduced in a quantity of 1 to 20% by weight, preferably between 1 and 15% by weight, particularly preferably 1 to 10% by weight in relation to the total weight of the plastic composition with the polymer.

These proportions cause a good flame retardant effect of the polymer and at the same time prevent a significant change in the properties of the plastic matrix both during processing and during use, in particular with regard to the mechanical properties and the thermal stability.

In a preferred embodiment, the polymer is introduced into the plastic matrix in a flame retardant composition with additional flame retardants, wherein preferably the flame retardant composition is contained in the plastic composition in a quantity of 2 to 30% by weight, preferably of 5 to 25% by weight, particularly preferably 10 to 25% by weight, most preferably 15 to 25% by weight in relation to the total weight of the plastic composition with a flame retardant composition.

On the one hand a good flame retardant effect of the flame retardant composition is ensured with these proportions and on the other hand, the processing and material properties of the plastic matrix are only slightly affected.

A plastic composition which contains the above-described polymer is also provided according to the invention.

In a preferred embodiment, after the first step of the method for producing the polymer according to the invention, the compound of formula III has exactly one free C—C-double bond in structural units in the form

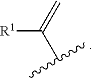

In the second step, a linear, unbranched polymer of structure V

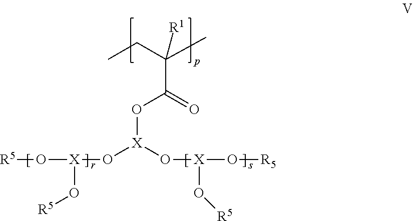

with the above-defined residues X, R¹ and R⁵ is then obtained, wherein r and s can be the same or different and the sum of r+s represents an average chain length in the range of 0-99 and p represents an average chain length in the range of 5-500.

### EXAMPLES

The invention will now be described in detail using production examples for the polymers according to the invention and examples of applications according to the invention in plastic matrices and the attached figures.

### Base Materials:

### Compound I:

PETA: Technical acrylate mixture from the company Arkema, consisting of pentaerythritol tetraacrylate and pentaerythritol trisacrylate. The molar ratio of pentaerythritol tetraacrylate to pentaerythritol trisacrylate determined by HPLC and ¹H-NMR analysis is approximately 2:1.
THEICTA: Tris[2-(acryloyloxy)ethyl] isocyanurate (CAS: 40220-08-4) from the company Sigma-Aldrich (product number: 407534) with an average acrylate functionality of approximately 2.9.
DPEHA: Technical acrylate mixture from the company Allnex consisting of dipentaerythritol hexaacrylate and dipentaerythritol pentaacrylate. The molar ratio of dipentaerythritol hexaacrylate to dipentaerythritol pentaacrylate determined by HPLC and ¹H-NMR analysis is approximately 3:2.
SR 295: Technical acrylate mixture SR 295 from the company Arkema with the major component pentaerythritol tetraacrylate and an average acrylate functionality of approximately 3.5.
TMP-TMA: trimethylolpropane trimethacrylate (CAS: 3290-92-4) from the company Sigma-Aldrich (product number: 246840) with an average methacrylate functionality of approximately 2.9.

### Compound II:

DOPO: 6H-dibenzo[c,e][1,2]-oxaphosphorin-6-oxide (CAS: 35948-25-5) from the company Euphos HCA.
DDPO: 5,5-dimethyl-1,2,3-dioxo-phosphorinan-2-oxide (CAS: 40901-60-2).

### Catalyst in the First Step:

Triethylamine 99% purity)

### Initiator in the Second Step:

2,2′-azobis(2-methylpropionitrile) (AIBN) from the company Sigma-Aldrich

### Measurement Methods

Differential scanning calorimetry (DSC) measurements were performed with a DSC 822e (Mettler Toledo; USA, Switzerland) in the range of 25 to 250° C. under a nitrogen atmosphere at a heating rate of 10 K/min. The weight of the samples was approximately 15 mg. The software STARe (Mettler Toledo) was used for the evaluation of the DSC curves.

Thermogravimetric analyses (TGA) were performed with a TGA Q500 V6.4 (TA Instruments; USA) in the range of 25 to 800° C. under a nitrogen atmosphere at a heating rate of 10 K/min. The weight of the samples was 12-15 mg. The software TA Universal Analysis 2000, Version 4.2E (TA Instruments) was used for the evaluation of the TGA curves.

### Example 0: Synthesis of a Partially Cross-Linked Polyacrylate Based on PETA (Prior Art of WO 2014/124933)

Step 1: Carrying Out the Phospha-Michael Addition

0.3 mol (105.7 g) PETA and 0.6 mol (129.7) DOPO were introduced into 700 ml toluene, with 0.6 mol (60.7 g) triethylamine and heated for 5 hours at 80° C. until complete conversion of the Michael addition (a control of the reaction of the initial materials was carried out by ³¹P and 1H-NMR analysis). Then, the supernatant phase was separated by decantation. The volatile components were removed on a rotary evaporator and the oily residue combined with the lower phase.

Step 2: Polymerisation of the Remaining Acrylate Groups

Subsequently, 600 ml toluene was added and heated under a nitrogen atmosphere. After reaching the boiling point, a solution of 0.1 g AIBN in 10 ml toluene was added in drops with vigorous stirring over 15 min. After a short time, a suspension of particles of a duromer was formed. This suspension was stirred under reflux for 2 hours. The still warm product was filtered off, washed with toluene (150 ml), dried in a fume hood overnight and finally heated in a vacuum drying oven to 210° C. (3 hours, approx. 6 mbar). This gave 223.6 g of product as a white powder (yield 95%).

### Example 1: Synthesis of a Meltable Polyacrylate Based on DPEHA

Step 1: Carrying Out the Phospha-Michael Addition

In a 2 l three-necked flask equipped with a KPG stirrer, reflux condenser with nitrogen transfer line, temperature measuring device and heated bath were added 0.25 mol (137.5 g) DPEHA and 800 ml toluene and 1.125 mol (243.2 g) DOPO. Subsequently, the reaction mixture was heated with stirring to 90° C., wherein the DOPO dissolved. After the addition of 0.225 mol (20.8 g) triethylamine, the mixture was heated to just below its boiling point (approx. 100° C., heated bath temperature 115° C.). Stirring under these conditions was continued for 4.5 hours, wherein two phases formed.

Step 2: Polymerisation of the Remaining Acrylate Groups

Subsequently, the nitrogen supply was started and the mixture was heated to a gentle boil for 2 hours (heated bath temperature approx. 122° C.). Then, with vigorous stirring, a solution of 0.05 g AIBN in 10 ml toluene was added in drops over 10 minutes. A polymer suspension was obtained within a few minutes. To complete the polymerisation reaction, stirring was continued for 1.5 hours under reflux. After cooling to approx. 60° C., the supernatant toluene solution was separated by decanting from the viscous polymer phase, the latter then initially dried in the air and then slowly heated to 210° in a vacuum drying oven at approx. 7 mbar, wherein a melt was obtained. After 4 hours at approx. 210° C. and 7 mbar, followed by cooling and solidification of the melt and grinding, a white powder was obtained (yield approx. 93%).

### Example 2: Synthesis of a Meltable Polyacrylate Based on PETA

Step 1: Carrying Out the Phospha-Michael Addition

In a 2 l three-necked flask equipped with a KPG stirrer, reflux condenser, temperature measuring device and heated bath were added 0.333 mol (110.1 g) PETA and 800 ml toluene and 0.833 mol (81.1 g) DOPO. Subsequently, the reaction mixture was heated with stirring to 90° C., wherein the DOPO dissolved. After the addition of 0.167 mol (17 g) triethylamine, the mixture was heated to just below its boiling point (approx. 100° C., heated bath temperature 115° C.). Stirring under these conditions was continued for 3.5 hours, wherein two phases formed. Examination of both phases by NMR spectroscopy showed that the DOPO had been fully reacted. Subsequently, the reflux condenser was equipped with a nitrogen transfer line, and the contents of the flask were cooled under nitrogen supply.

Step 2: Polymerisation of the Remaining Acrylate Groups

After 15 hours of storage at room temperature, the reaction mixture was heated under nitrogen supply (low boiling, heated bath temperature 115° C.) and stirred for 2 hours at a constant temperature. The heated bath temperature was then increased to 125° C. so that more vigorous boiling occurred. Subsequently, 5 g of a 0.2 molar AIBN solution was added in portions into toluene over 5 minutes. The mixture was stirred vigorously so that both phases mixed in an emulsion-like manner. Within approx. 10 minutes, a viscous substance separated which became more viscous during the further heating and accumulated on the bottom of the flask. After the reaction mixture was heated to reflux for 90 minutes, the heating was turned off. After cooling to approx. 60° C., the toluene phase was separated by decantation and transferred the viscous substance in a coated metal shell. First, it was dried in the air, then heated in a vacuum drying oven for approx. 14 hours at 150° C., wherein the pressure was slowly reduced to approx. 10 mbar (initially the substance foamed and inflated). It was then heated to 215° C. for 4 hours at approx. 10-13 mbar. After cooling and crushing, the thermoplastic was obtained as a white, chloroform-soluble solid (276 g, 95% yield).

### Example 3: Synthesis of a Meltable Polyacrylate Based on THEICTA

Step 1: Carrying Out the Phospha-Michael Addition

In a 1 l three-necked flask equipped with a KPG stirrer, reflux condenser with argon transfer line, temperature measuring device and heated bath were added 0.142 mol (60.0 g) THEICTA, 0.269 mol (58.2 g) DOPO and 300 ml toluene. After the mixture was boiled and the initial materials were dissolved, a mixture of 5.1 ml of triethylamine and 20 ml of toluene was added in drops. The contents of the flask were stirred at reflux for 4 hours, wherein the initially homogeneous mixture became two-phase.

Step 2: Polymerisation of the Remaining Acrylate Groups

The supply of argon was then started. After a further 30 minutes, 0.8 ml of a 2 molar AIBN solution in toluene was added with vigorous stirring. After a few minutes, the viscosity of the lower phase had greatly increased due to the polymerisation. It was heated for another hour under slow stirring and argon atmosphere to reflux. After cooling to approx. 60° C., the upper phase was separated by decantation and then the viscous product phase removed from the flask. The latter was slowly heated to 180° in a vacuum drying oven at approx. 7 mbar. After 4 hours at approx. 180° C. and 7 mbar, followed by cooling and solidification of the melt and grinding, a white powder was obtained (yield 92%).

### Example 4: Synthesis of a Meltable Polyacrylate Based on DPEHA

Step 1: Carrying Out the Phospha-Michael Addition

In a 1 l three-necked flask equipped with a KPG stirrer, reflux condenser with nitrogen transfer line, temperature measuring device and heated bath were added 0.1 mol (54.95 g) DPEHA, 0.43 mol (64.55 g) DOPO and 200 ml toluene. Then, 0.43 mol (43.5 g) triethylamine was added and the contents of the flask were heated to 80-85° C. with stirring for five days. The solvent and triethylamine were then removed on a rotary evaporator. A ³¹-P-NMR sample of the distillation residue showed that the DDPO had been completely reacted.

Step 2: Polymerisation of the Remaining Acrylate Groups

After addition of 350 ml toluene and transfer into a three-necked flask, the nitrogen feed was started and stirred for 2 hours at a low boil (oil bath temperature approx. 120° C.). Subsequently, a solution of 0.05 g AIBN in 5 ml of toluene was added in drops over 3 min, while stirring vigorously. The resulting polymer suspension was stirred for 0.5 hours at a constant temperature. After cooling to approx. 60° C., the toluene phase was separated from the viscous polymer phase by decantation and the still warm polymer phase was removed from the flask. The substance thus obtained was slowly heated to 190°, wherein the pressure was lowered to approx. 7 mbar and these conditions were maintained for 3 hours. After grinding the cooled polymer melt, a white powder was obtained (yield 89%).

### Example 5: Synthesis of a Meltable Polyacrylate Based on SR 295

Step 1: Carrying Out the Phospha-Michael Addition

To a round-bottom flask was added 0.377 mol (124.7 g) SR 295, 600 ml toluene and 0.25 mol (25 g) triethylamine. After the contents of the flask were heated to 93° C., the first portion of DOPO (0.10 mol, 21.6 g) was added. After 20 min of stirring at 95° C., a second DOPO portion (0.10 mol, 21.6 g) was added. Eight further DOPO portions (each 21.6 g) were added at 20-minute intervals at the same temperature while stirring the reaction mixture. During the reaction, a phase separation took place. Once the DOPO addition was complete, stirring was carried out for another hour at 95° C. Subsequently, the reflux condenser was equipped with a nitrogen supply line and the heating was turned off. After stopping the stirrer, the product phase collected at the bottom of the flask. The product phase and the overlying phase were examined by NMR spectroscopy, wherein a complete conversion of the DOPOs was determined. The contents of the flask were stored overnight at room temperature.

Step 2: Polymerisation of the Remaining Acrylate Groups

The next day, the reaction mixture was heated at 90° C. over 30 min. Then it was stirred under nitrogen atmosphere for 1.5 hours at 90-95° C. The contents of the flask were stirred vigorously to form a milky emulsion. After the reaction mixture was heated to reflux, 3.0 g (3.5 ml) of a 0.2 molar AIBN solution was added over 3 min. The polymerisation started immediately. After 10 min, a second AIBN portion (1 g) was added, and after a further 5 min, a third portion (1 g) was added. During the polymerisation process, the reaction mixture became increasingly viscous, but it could still be stirred (at reduced stirrer speed). Stirring under reflux was continued for 2 hours. The stirrer and oil bath were then turned off. After cooling to approx. 60° C., the toluene phase was removed by decantation. The viscous liquid remaining after decantation was poured into a stainless steel pan where it slowly solidified to a solid which was crushed. The product was first dried in a vacuum drying oven for 8 h at 50° C./30 mbar, wherein it was prone to foaming. Then, the drying temperature was raised to 100° C. over 12 hours. The product was then dried in vacuo at 150-200° C., and finally heated to 240° C. over 4 hours. The polymer melt thus obtained was poured into a stainless steel pan, where it solidified. Subsequently, the resulting polymer was crushed to a white powder. The yield was 96% and the melting point (Tₘ) was in the range of 100-140° C.

### Example 6: Synthesis of a Meltable Polymethacrylate Based on TMP-TMA

Step 1: Carrying Out the Phospha-Michael Addition

To a round bottom flask containing 120 ml toluene was added 0.20 mol (67.7 g) TMP-TMA, 0.2 mol (20.4 g) triethylamine and 0.15 mol (32.4 g) DOPO, and the contents of the flask was heated to 95° C. After 1 hour of stirring, a second DOPO portion (0.11 mol, 23.8 g) was added. Two further DOPO portions (each 0.08 mol, 17.3 g) were added at intervals of 1 hour at a constant temperature with stirring and then the reaction mixture was stirred at 95° C. for 1 hour. Subsequently, the reflux condenser was equipped with a nitrogen feed line, the heating was turned off and a reaction control by NMR spectroscopy was performed. The contents of the flask were stored overnight at room temperature.

Step 2: Polymerisation of the Remaining Methacrylate Groups

The next day, 0.17 mol (21.8 g) butyl acrylate was added, the reaction mixture was heated to 97° C. and stirred for 1.5 hours under a nitrogen atmosphere. Subsequently, 2.5 ml of a 0.2 molar AIBN solution was added over 1.5 min and stirred for a further 45 min. The stirrer and oil bath were then turned off and a reaction monitored by NMR spectroscopy, wherein a complete conversion of the double bonds of the monomers could be determined. The round-bottom flask was equipped with a distillation head, the flask was heated to 150° C. and the pressure gradually lowered to approx. 3 mbar, removing the volatile components. After cooling, a transparent, brittle solid was obtained. The yield was 95% and the melting point (Tₘ) of the product was in the range of 90-120° C.

The following overview summarises the initial compounds I and II, their molar amounts and the average number of structural units in the form

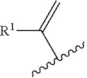

in the compounds I and III in the described Examples 0 to 6 combined.

| Example | Compound I | Mol compound I | 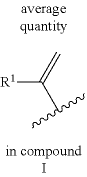 | Compound II | Mol compound II | 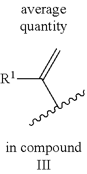 |
|---|---|---|---|---|---|---|
| 0 | PETA | 0.3 | 3.7 | DOPO | 0.6 | 1.7 |
| 1 | DPEHA | 0.25 | 5.6 | DOPO | 1.125 | 1.1 |
| 2 | PETA | 0.333 | 3.7 | DOPO | 0.833 | 1.2 |
| 3 | THEICTA | 0.142 | 2.9 | DOPO | 0.269 | 1.0 |
| 4 | DPEHA | 0.1 | 5.6 | DDPO | 0.43 | 1.3 |
| 5 | SR 295 | 0.377 | 3.5 | DOPO | 1 | 0.8 |
| 6 | TMP-TMA | 0.2 | 2.9 | DOPO | 0.42 | 0.8 |

### Flame Retardant Examples

Compositions

In order to check the flame retardant effect and to classify the flame retardant compositions according to the invention in different polymers, the UL94 test was carried out on IEC/DIN EN 60695-11-10 standard-compliant specimens.

UL94 Test

For each measurement, 5 specimens were clamped in a vertical position and held at the free end of a Bunsen burner flame. The burning time as well as the falling of burning parts were evaluated by means of a cotton swab arranged under the specimen. The exact performance of the experiments and the flame treatment with a 2 cm high Bunsen burner flame was carried out according to the specifications of Underwriter Laboratories, Standard UL94.

The results given are classifications in fire protection classes V-0 to V-2. Here, V-0 means that the total burning time of 5 specimens tested was less than 50 seconds and the cotton swab was not ignited by dripping, glowing or burning components of the specimen. The rating V-1 means that the total burning time of 5 specimens tested was more than 50 seconds but less than 250 seconds and that the cotton swab was not ignited. V-2 means that the total burning time of 5 specimens tested was less than 250 seconds, the cotton swab was ignited by dripping test specimen constituents in at least one of the 5 tests. The abbreviation NC stands for ‘not classifiable’ and means that a total burning time of more than 250 seconds was recorded. In many nonclassifiable cases, the specimen burned completely.

Polymers

The following plastic matrices were used in the following examples to prepare the flame retardant plastic compositions:

| | | |
|---|---|---|
| Example 7 | PBT | Lanxess Pocan B1400 with 35% by |
| | 35 GF | weight glass fibres Lanxess CS 7968 |
| Example 8 | PBT | Lanxess Pocan B1400 |
| Example 9 | PA6.6 | Albis Altech A1000/109 natur NC000100 |
| Example 10 | PC | Sabic GE Lexan 141R |

Flame Retardant:

MPP: Melamine polyphosphate Budit 342 from the company Chemische Fabrik Budenheim

MC: Melamine cyanurate Budit 315 from the company Chemische Fabrik Budenheim

ZPP: Zinc pyrophosphate Budit T34 from the company Chemische Fabrik Budenheim

FR 1025: Poly(pentabromobenzyl acrylate) from the company ICL Industrial

Exolit: Exolit OP 1230, organic phosphinate from the company Clariant

P-D: P-containing duromer form the prior art, produced according to Example 0

P-T: P-containing thermoplastic according to the invention, produced according to Example 5.

### Example 7: Replacement of Antimony Oxide in Flame Retardant Glass Fibre-Reinforced PBT Specimens

Glass fibre-reinforced PBT compounds (PBT 35GF) were produced using a twin-screw extruder process 11 (Thermo Scientific) under PBT standard extrusion conditions. The extrusion process was carried out at a rate of approximately 300 g per hour and a temperature of 260-265° C., wherein a granulate having a grain size of approximately 3×1×1 mm was obtained, from which hot-pressed UL94 specimens of good quality were produced. The thickness of the specimens was 1.6 mm. In the extrusion process, the DOPO-functionalised polyacrylate prepared according to Example 5 was incorporated together with the bromine-containing flame retardant poly(pentabromobenzyl acrylate) (FR1025; ICL Industrial. For comparison, compounds were produced which contained only FR 1025 and compounds with the flame retardant combination FR 1025/Sb₂O₃, wherein for the latter the additive concentrations necessary to achieve V0 were used. The compositions of the PBT specimens (% by weight) and the results of the UL94 tests are summarised in Table 1.

The production of the specimens of the further Examples 8-10 was carried out in the same way, taking into account the extrusion conditions required for the respective polymer matrix.

TABLE 1

| | PBT | FR1025 | Sb₂O₃ | PTFE | P-D | P-T | | t_{ges}^{a)} | |
|---|---|---|---|---|---|---|---|---|---|
| # | [%] | [%] | [%] | [%] | [%] | [%] | UL94 | [s] | Remarks |
| 0 | 100 | — | — | — | — | — | n.c. | — | Burns through |
| | | | | | | | | | to the clamp |
| 1 | 88 | 12 | — | — | — | — | V2 | 42 | |
| 2 | 82 | 12 | 6 | | | | V0 | 0 | 1 drip after |
| | | | | | | | | | 2nd flame treat- |
| | | | | | | | | | ment |
| 3 | 82 | 12 | — | — | — | 6 | V0 | 17 | No dripping |
| 4 | 82 | 14 | — | — | — | 4 | V1 | 54 | |
| 5 | 82 | 16 | — | — | — | 2 | V2 | 18 | 1 burning drip |
| 6 | 82 | 9.6 | 4.8 | — | — | 3.6 | V0 | 2 | No dripping |
| 7 | 81.9 | 12 | 6 | 0.1 | — | — | V0 | 0 | 1 drip after |
| | | | | | | | | | 1st flame treat- |
| | | | | | | | | | ment |
| 8 | 81.9 | 12 | — | 0.1 | 6 | — | V0 | 10 | 1 drip after |
| | | | | | | | | | 2nd flame treat- |
| | | | | | | | | | ment |
| 9 | 82 | 12 | — | — | 6 | — | V0 | 17 | No dripping |

^{a)}Total burning time of 10 flame treatments for five specimens

Comparison of the results of specimens #2 and #3 shows that a flame retardant combination of the thermoplastic according to the invention with poly(pentabromobenzyl acrylate) achieves the same V0 classification as a flame retardant composition of poly(pentabromobenzyl acrylate) and the noxious Sb₂O₃. Furthermore, no dripping is observed when using the polymer according to the invention. This means that it is also possible to dispense with the addition of anti-dripping agents such as PTFE. Comparison of specimen #3 with specimens #8 and #9 shows that with the thermoplastic according to the invention a comparable flame retardant effect can be achieved as with the duromers of the prior art.

### Example 8: Flame Retardant Properties of PBT Specimens with the Polymer According to the Invention Compared to the Prior Art

TABLE 2

| | | Glass | | | | | | | | t_{burn.} |
|---|---|---|---|---|---|---|---|---|---|---|
| | PBT | fibre^{a)} | FR 1025 | Sb₂O₃ | P-D | P-T | MC | MPP | | t_{1/}t₂ |
| # | [%] | [%] | [%] | [%] | [%] | [%] | [%] | [%] | UL94 | [S] |
| 0 | 52 | 30 | 12 | 6 | — | — | — | — | V2 | 1.2/0.0 |
| 1 | 52 | 30 | 12 | — | 6 | — | — | — | n.c. | 14.0/9.2 |
| 2 | 52 | 30 | 12 | — | | 6 | — | — | V2 | 1.3/1.0 |
| 3 | 52 | 30 | — | — | — | — | 18 | — | V2 | 3.1/1.0 |
| 4 | 52 | 30 | — | — | — | 9 | 9 | — | V2 | 1.0/1.0 |
| 5 | 50 | 30 | — | — | — | — | 20 | — | V2 | 4.1/1.4 |
| 6 | 50 | 30 | — | — | — | 10 | 10 | — | V2 | 1.8/1.0 |
| 7 | 50 | 30 | — | — | — | — | — | 20 | n.c. | 6.8/7.1 |
| 8 | 50 | 30 | — | — | — | 10 | — | 10 | V2 | 5.6/1.1 |

^{a)}Lanxess CS 7968

Comparison of the results of specimens #0 and #2 shows that by the addition of the thermoplastic according to the invention to PBT, a similarly high flame retardant effect can be achieved as with the noxious Sb₂O₃. The flame retardant effect of the duromer of the prior art (specimen #1) remains well behind the thermoplastic according to the invention (specimen #2). Comparison of the specimens #3, #5 and #7 with the specimens #4, #6 and #8 illustrates that a flame retardant composition of a known flame retardant such as MC or MPP and the thermoplastic according to the invention has a better flame retardant effect than the known flame retardant alone. This is obviously due to a synergistic effect. The burning time of the specimens is significantly reduced in all cases.

### Example 9: Flame Retardant Properties of Glass Fibre-Reinforced PA6.6 Specimens with the Polymer According to the Invention Compared to the Prior Art

TABLE 3

| | | Glass | | | | | | | t_{burn.} |
|---|---|---|---|---|---|---|---|---|---|
| | PA6.6 | fibre | P-D | P-T | MPP | ZPP | Exolit | | t_{1/}t₂ |
| # | [%] | [%]^{a)} | [%] | [%] | [%] | [%] | [%] | UL94 | [S] |
| 0 | 47 | 30 | 3.29 | — | 16.43 | 1.10 | 2.19 | V0 | 8/10 |
| 1 | 47 | 30 | — | 3.29 | 16.43 | 1.10 | 2.19 | V0 | 5/5 |
| 2 | 47 | 30 | 3.45 | — | 17.25 | — | 2.3 | V0 | 7/11 |
| 3 | 47 | 30 | | 3.45 | 17.25 | — | 2.3 | V0 | 5/5 |
| 4 | 47 | 30 | 2.3 | — | 19.55 | 1.15 | — | n.c. | 39/47 |
| 5 | 47 | 30 | — | 2.3 | 19.55 | 1.15 | — | V2 | 20/20 |

^{a)}Lanxess CS 7928

Comparison of the specimens #0, #2, #4 with the specimens #1, #3, #5 shows that by the addition of the thermoplastic according to the invention to PA6.6 a better flame retardant effect is achieved than with the duromer of the prior art. The burning time of the specimens is significantly reduced in all cases.

### Example 10: Flame Retardant Properties of Polycarbonate Specimens with the Polymer According to the Invention Compared to the Prior Art

TABLE 4

| | | | | | t_{burn.} | Young's | Tensile |
|---|---|---|---|---|---|---|---|
| | PC | P-D | P-T | | t_{1/}t₂ | modulus | strength |
| # | [%] | [%] | [%] | UL94 | [S] | [MPa] | [MPa] |
| 0 | 100 | — | — | V2 | 18/10 | 2586 | 67.7 |
| 1 | 95 | 5 | — | V2 | 14/12 | 2889 | 73.2 |
| 2 | 95 | — | 5 | V2 | 12/10 | 2732 | 72.7 |
| 3 | 90 | — | 10 | V0 | 6/7 | 2915 | 77.1 |
| 4 | 85 | — | 15 | V0 | 4/1 | 3049 | 78.1 |
| 5 | 80 | — | 20 | V0 | 0/0 | 3144 | 79.2 |

The results show that the addition of the polymer according to the invention leads to a significant reduction of the combustion period of the PC test specimen. The comparison of test pieces #1 and #2 makes it clear that the flame retardant effect of the thermoplastic polymer according to the invention is greater than that of the duromer from the prior art.

### DESCRIPTION OF THE FIGURES

The attached figures represent thermogravimetric and NMR spectroscopic measurements, in which:

FIG. 1: shows the thermogravimetric measurement of a polymer according to the prior art (Example 0).

FIG. 2: shows the thermogravimetric measurement of a polymer according to the invention (Example 5).

FIG. 3: shows the thermogravimetric measurement of a polymer according to the invention (Example 6).

FIG. 4: shows the ¹H-NMR spectrum of a polymer according to the invention (Example 6).

FIG. 5: shows the ³¹P-NMR spectrum of a polymer according to the invention (Example 6).

FIG. 1 shows the weight loss of a polymer according to the prior art (Example 0) according to the temperature in a thermogravimetric measurement in the range of 20° C. to 550° C., wherein the initial weight is given as 100%. Above 480° C., a nearly constant residual mass of approximately 13% of the original sample mass was established.

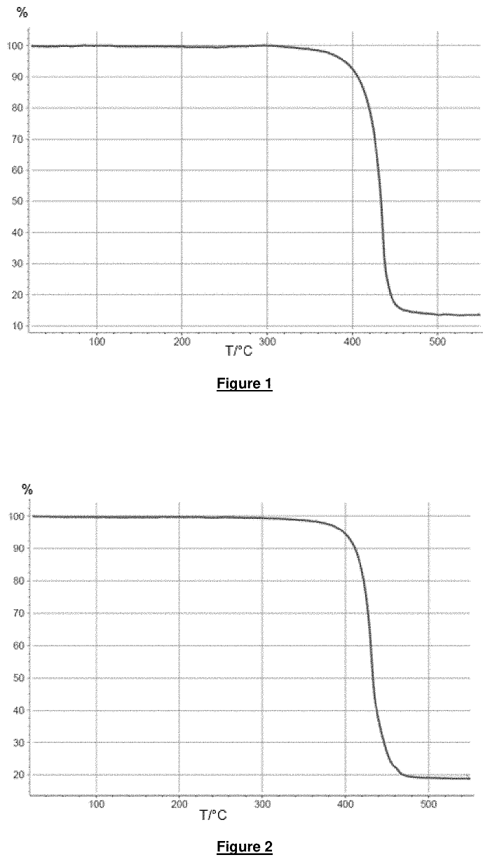

FIG. 2 shows the process of a corresponding thermogravimetric measurement on a polymer sample according to the invention (Example 5). With the polymer sample according to the invention, above 480° C. a nearly constant residual mass of approximately 19% of the original sample mass was established.

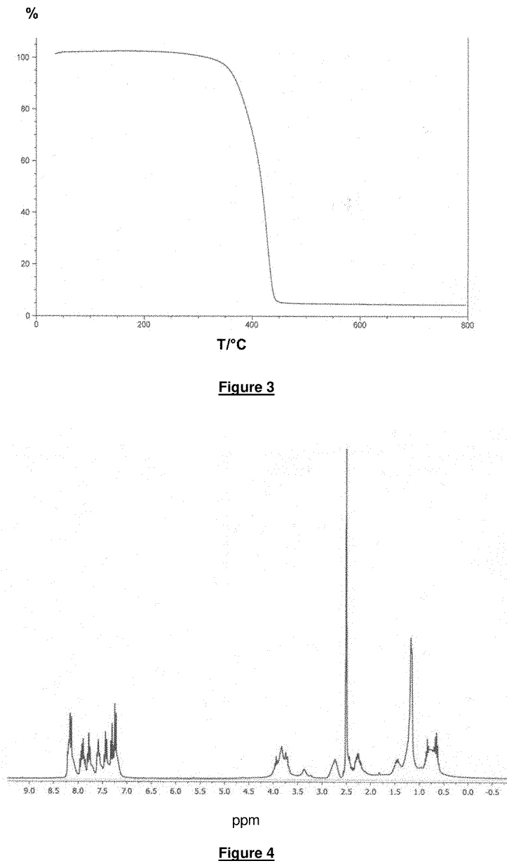

FIG. 3 shows the process of a corresponding thermogravimetric measurement on a polymer sample according to the invention (Example 6). With the polymer sample according to the invention, above 450° C. a nearly constant residual mass of approximately 5% of the original sample mass was established.

The following Table 5 compares at which temperatures residual masses of 98%, 96% or 94% by weight of the initial weight have been established with the sample according to the prior art (Example 0) and with the sample according to the invention (Example 5).

TABLE 5

| | Example 0 | Example 5 |
|---|---|---|
| | (prior art) | (invention) |
| Residual mass | Temperature | Temperature |
| [% by weight] | [° C.] | [° C.] |
| 98 | 368.2 | 371.2 |
| 96 | 385.2 | 392.9 |
| 94 | 394.9 | 402.3 |

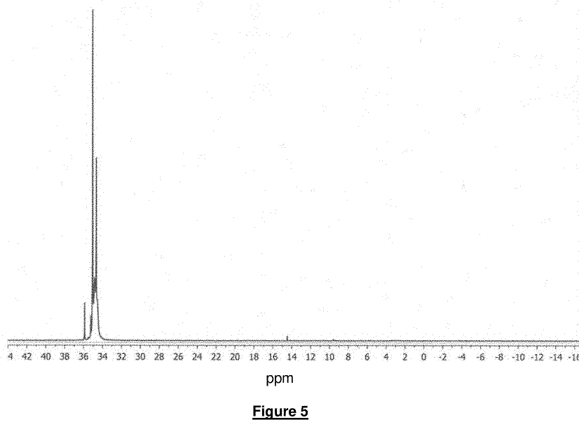

FIG. 4 shows the ¹H-NMR spectrum of a polymer according to the invention (Example 6) within the range of −0.5 to 9.0 ppm. The aromatic signals of the DOPO-functionalised recurring units can be recognised in the range from 7.0 to 8.5, whereas the aliphatic signals of the recurring units are between 0.0 and 4.5 ppm. Due to the absence of olefinic signals in the range from approximately 5.5 to 6.5 ppm, an almost complete conversion of the compounds of formula III and IV can be concluded in the second reaction step.

FIG. 5 shows the ³¹P-NMR spectrum of a polymer according to the invention (Example 6) in the range of −16 to 44 ppm. In the spectrum, only a wide polymer signal can be made out.

1. A polymer which can be obtained by a method in which in a first step a compound or a mixture of compounds with the general formula I 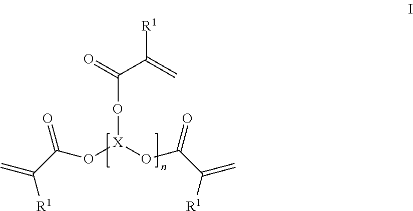
is reacted with a compound with the general formula II or a mixture of compounds with the general formula II
R²—H II
to obtain a compound with the general formula III or a mixture of compounds with the general formula III 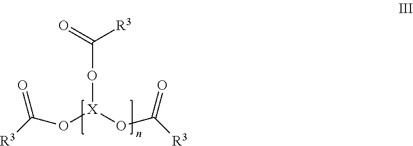
wherein the compound with the general formula III or the mixture of compounds with the general formula III in a second step with the optional addition of one or a plurality of methacrylates and/or acrylates with the general structure IV 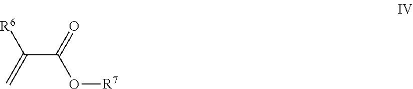
is reacted into a polymer, where
R¹ is hydrogen, a C₁-C₆ alkyl, a C₆-C₁₂ aryl or a C₆-C₁₂ alkylaryl,
R² is 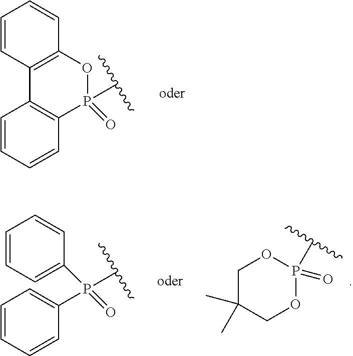
R³ is 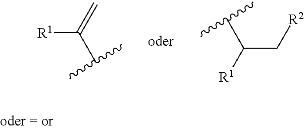
and where X is 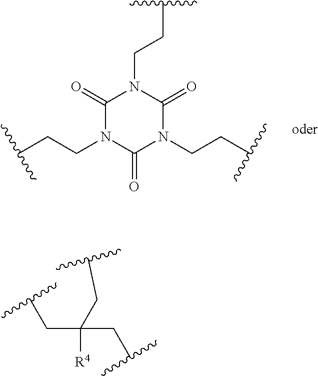
where R⁴ is hydrogen, —CH₂OH, —OH, a C₁-C₆-alkyl, a C₆-C₁₂-aryl, a C₆-C₁₂-alkylaryl or 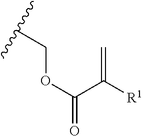
R⁶ and R⁷ independently of one another are hydrogen, C₁-C₆-alkyl, C₆-C₁₂-aryl or C₆-C₁₂-alkylaryl and
in the compounds according to formulae I and III or the mixtures of compounds according to formulae I and III n represents an average chain length in the range of 1 to 100, preferably 1 to 10, particularly preferably 1 to 3,
wherein the average number of R³ residue of the formula 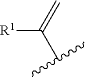
in the compound of formula III or in the mixture of the compound of formula III is 0.8 to 1.3 and the polymer is a thermoplastic.

2. The polymer according to claim 1, wherein the weight proportion of phosphorus is at least 8.5% by weight.

3. The polymer according to claim 1, wherein compound I is selected from among pentaerythritol tetraacrylate (PETA), dipentaerythritol hexaacrylate (DPEHA) and tris(2-acryloxyethyl) isocyanurate (THEICTA).

4. The polymer according to claim 1, wherein the reaction in the first step takes place under catalysis with a catalyst which is selected from among tertiary amines and tertiary amino bases, preferably triethylamine.

5. The polymer according to claim 1, wherein the reaction in the second step takes place by emulsion or suspension polymerisation.

6. The polymer according to claim 1, wherein the number average of the molar mass of the polymer (M̅ₙ) is at least 20,000 g/mol.

7. A method for producing a polymer which comprises the method measures defined in claim 1.

8. The method according to claim 7, wherein the second step is carried out with the addition of one or a plurality of methacrylates and/or acrylates of the general structure IV, 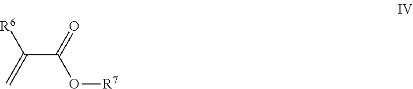
wherein the compounds of formula IV and formula III are incorporated in a molar ratio, in that the obtained polymer contains a weight proportion of ≥6% by weight phosphorus.

9. A flame retardant composition which comprises a polymer according to claim 1.

10. The flame retardant composition according to claim 9, which contains at least one additional flame retardant component selected from among nitrogen bases, melamine derivatives, phosphates, pyrophosphates, polyphosphates, organic and inorganic phosphinates, organic and inorganic phosphonates and derivatives of the aforementioned compounds, preferably selected from among ammonium polyphosphate, with melamine, melamine resin, melamine derivatives, silanes, siloxanes, silicones or polystyrenes coated and/or coated and cross-linked ammonium polyphosphate, as well as 1,3,5-triazine compounds, including melamine, melam, melem, melon, ammeline, ammelide, 2-ureidomelamine, acetoguanamine, benzoguanamine, diaminophenyl triazine, melamine salts and adducts, melamine cyanurate, melamine borate, melamine orthophosphate, melamine pyrophosphate, dimelamine pyrophosphate, aluminium diethylphosphinate and melamine polyphosphate, oligomeric and polymeric 1,3,5-triazine compounds and polyphosphates of 1,3,5-triazine compounds, guanine, piperazine phosphate, piperazine polyphosphate, ethylenediamine phosphate, pentaerythritol, dipentaerythritol, boron phosphate, 1,3,5-trihydroxyethyl isocyanurate, 1,3,5-triglycidyl isocyanurate, triallyl isocyanurate and derivatives of the aforementioned compounds.

11. The flame retardant composition according to claim 10, wherein the ratio of the polymer to the at least one additional flame retardant component in the flame retardant composition is 1:18 to 1:4.

12. A method comprising adding the polymer according to claim 1 as a flame retardant in the production of plastic compositions.

13. The method according to claim 12, wherein the plastic compositions are selected from among filled and unfilled polyamides, polyesters and polyolefins.

14. The method according to claim 12, wherein the polymer is introduced in a quantity of 1 to 20% by weight, preferably between 1 and 15% by weight, particularly preferably 2 to 10% by weight in relation to the total weight of the plastic composition with the polymer.

15. The method according to claim 12, wherein the polymer is in a flame retardant composition when introduced into the plastic composition, wherein the flame retardant composition is contained in the plastic composition in a quantity of 2 to 30% by weight in relation to the total weight of the plastic composition with the flame retardant composition.

16. A plastic composition which contains the polymer according to claim 1.

17. The polymer according to claim 1, wherein a structure of the general formula V comprises 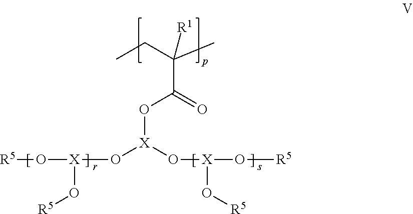
where
R¹ is hydrogen, a C₁-C₆ alkyl, a C₆-C₁₂ aryl or a C₆-C₁₂ alkylaryl,
R⁵ is 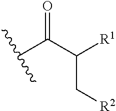
R² is 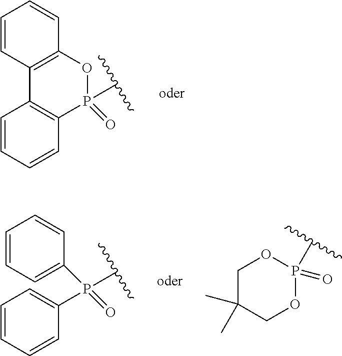
X is 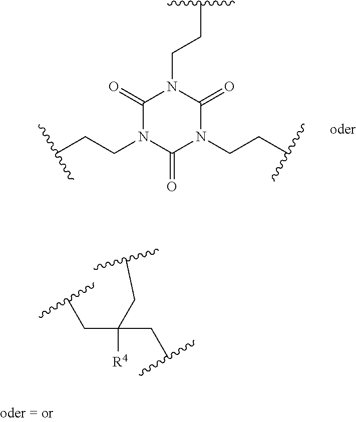
and, where R⁴ is hydrogen, —CH₂OH, —OH, a C₁-C₆-alkyl, a C₆-C₁₂-aryl, a C₆-C₁₂-alkylaryl or 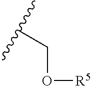
and where
R¹, R², R⁴, R⁵ and X can each be the same or different and r and s can be the same or different and the sum of r+s represents an average chain length in the range of 0-99 and p represents an average chain length in the range of 5-500.
